(19) United States
(12) Patent Application Publication
(10) Pub. No.: US 2023/0383127 A1
(43) Pub. Date: Nov. 30, 2023

(54) BORONIC ESTERS AND COATINGS COMPRISING THEM

(71) Applicant: PETROLIAM NASIONAL BERHAD (PETRONAS), Kuala Lumpur (MY)

(72) Inventors: Mohd Shamsul Farid SAMSUDIN, Kuala Lumpur (MY); Norfarah Diana ABA, Kuala Lumpur (MY); Muzdalifah ZAKARIA, Kuala Lumpur (MY); Kok Hoong LEONG, Kuala Lumpur (MY); Jane ZHANG, Kuala Lumpur (MY); Russell VARLEY, Kuala Lumpur (MY); Mandy DESOUZA, Kuala Lumpur (MY); Azmi M NOOR, Kuala Lumpur (MY)

(73) Assignee: PETROLIAM NASIONAL BERHAD (PETRONAS), Kuala Lumpur (MY)

(21) Appl. No.: 18/249,591

(22) PCT Filed: Oct. 13, 2021
(86) PCT No.: PCT/MY2021/050088

§ 371 Date: Apr. 19, 2023

(30) Foreign Application Priority Data
Oct. 19, 2020 (MY) PI2020005484
Nov. 4, 2020 (MY) PI2020005777

(51) Int. Cl. C09D 5/08; C09D 175/08; C09D 185/04

(52) U.S. Cl. CPC C09D 5/086; C09D 175/08; C09D 185/04

(57) ABSTRACT

The present invention relates to a coating comprising a (i) boronic ester of Formula (I) disclosed herein, and (ii) an elastomer, wherein (i) and (ii) are cured with pentaerythritol tetrakis(3-mercaptoptopionate) (PTMP) and 3,6-dioxa-1,8-octanedithiol (DODT).

### TECHNICAL FIELD

The present invention generally relates to boronic esters and coatings comprising them. The coatings may be useful for their self-healing properties as protective anti-corrosive coatings for the oil and gas industry.

### BACKGROUND ART

The oil and gas industry is one of the biggest economic sectors in the world, involving the need to drill, transport, store, process, and purify these natural gas and crude oil into various forms of petroleum and petrochemical products. Fuel is an essential source of energy. Furthermore, these petrochemicals are crucial to many industries as it is the primary source of material to produce other chemicals such as pesticides, pharmaceuticals, fertilisers, solvents and plastics.

With the current volatility in the demand and prices of fuel, and the stringent environmental regulations, the oil and gas industry faces major challenges which includes reducing cost, increasing efficiency, and improving productivity and environmental foot print. To achieve these outcomes, the oil and gas industry needs to tackle one of its main issues: corrosion.

Corrosion of the oil and gas infrastructures, such as the pipelines, installations, connections, tubing and process systems, has a significant impact on the integrity of the metals and the performance of the oil and gas processes. Corrosion can form pits and decrease mechanical efficiencies, eventually leading to leaks. Thus corrosion in the oil and gas infrastructures increases the production cost and environmental footprint and decreases efficiency and output.

With the long-term exposure and harsh conditions (e.g. high temperature, salinity, and humidity, and presence of pollution, sand and dust) experienced by the oil and gas industry, it further speed up the process of corrosion, and prematurely reduce the lifespan of these metal infrastructures. Wear and tear of these metal infrastructure are also unavoidable under the presence of corrosive elements, such as carbon dioxide (CO₂), hydrogen sulphide (H₂S) and water (H₂O).

To protect these metal infrastructures and avoid corrosion, there are several ways, for example applying sacrificial or protective coatings, undergoing chemical treatment and adding corrosion inhibitors. One of the most cost-effective solution is to apply protective coatings. These coatings have been widely used on these metal substrates to form an additional barrier. Some examples of coating compositions include the use of any of the following compounds such as polysiloxane, epoxy, polymers, phosphate ester, and boronic ester.

With the additional protective coatings applied, it protects the metal substrates from the corrosive elements and prolongs the lifespan of the metal infrastructures. However, the applied protective coating can still be scratched and permanently damaged by the environment and mechanical impacts during transportation and installation. Once the coating is damaged, the metal would be exposed and can corrode.

Additionally, the quality and nature of the protective coating compositions may not be highly stable, robust and durable in the long-term exposure and harsh conditions experienced by the oil and gas industry. Possible degradation and deterioration of the coating may occur, resulting in the inability to protect the metal from corrosion.

To prevent corrosion and remediate the situation, a touch-up, or even a complete re-application of the protective coating is required. Even so, it is very challenging to quickly identify the internal and/or external corrosion and put in place any maintenance effectively.

Furthermore, maintenance processes are costly and cumbersome. Also, the quality of repair onsite (offshore conditions) may not be the same as the repair conducted in the factory or in a more controlled environment.

Without timely and effective repair to the coating on the metal substrate, continued damage can create conduits for the rapid intake of corrosive media, and eventually leading to premature coating failure, leaks, loss of output and equipment downtime.

Apart from the oil and gas industry, the issue of corrosion on metal substrates are also evident in other industrial applications.

Hence, there is a need to provide a protective coating composition that overcomes, or at least ameliorates, one or more of the disadvantages described above.

### SUMMARY OF INVENTION

According to a first aspect, there is provided a coating comprising:
(i) a compound of Formula (I):

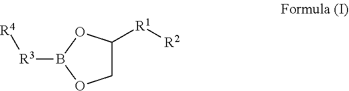

wherein:
R¹ is an optionally substituted alkylene bridge of C₁ to C₁₂ carbon atoms where one or more carbon atoms can be replaced by O, N or S;
R² is alkene or epoxide;
R³ is optionally substituted aryl, optionally substituted heteroaryl or optionally substituted carbocyclyl; and
R⁴ is alkene, epoxide, —R⁵-alkene or —R⁵-epoxide, wherein R⁵ is an optionally substituted alkylene bridge of C₁ to C₁₂ carbon atoms where one or more carbon atoms can be replaced by O, N or S; and
(ii) an elastomer;
wherein (i) and (ii) are cured with pentaerythritol tetrakis(3-mercaptoptopionate) (PTMP) and 3,6-dioxa-1,8-octanedithiol (DODT).

Advantageously, the coating may be a self-healing coating. The self-healing mechanism may advantageously be an intrinsic healing mechanism which is activated only from the surrounding environment. Further advantageously, the self-healing coating may be an autonomous healing material that is able to heal time and time again.

Further advantageously, the elastomer in the coating may possess high elasticity and its presence in the coating may provide an additional healing through a viscoelastic “spring back” of the scratches or cracks to further improve healing.

According to a further aspect, there is provided a method of self-healing cracks that form in a coating disclosed herein, wherein said crack is exposed to moisture thereby inducing esterification between hydroxy groups located on either side of said crack, thereby at least partially bonding the edges of said crack together.

According to another aspect, there is provided a pipeline comprising the coating disclosed herein.

According to another aspect, there is provided a method for synthesizing the coating disclosed herein comprising:
(a) preparing a mixture comprising a compound of Formula (I) disclosed herein, pentaerythritol tetrakis (3-mercaptoptopionate) (PTMP), 3,6-dioxa-1,8-octanedithiol (DODT), elastomer and photoinitiator; and
(b) curing the mixture of step (a).

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

As used herein, the term “alkyl” includes within its meaning monovalent (“alkyl”) and divalent (“alkylene”) straight chain or branched chain saturated aliphatic groups having from 1 to 20 carbon atoms, e.g., 1, 2, 3, 4, 5, 6, 7, 8, 9, 10, 11, 12, 13, 14, 15, 16, 17, 18, 19, or 20 carbon atoms. For example, the term alkyl includes, but is not limited to, methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, octyl, nonyl, decyl, undecyl, dodecyl, tridecyl, tetradecyl, pentadecyl, hexadecyl, heptadecyl, octadecyl, nonadecyl, eicodecyl and the like. Alkyl groups may be optionally substituted.

The term “aryl”, or variants such as “aromatic group” as used herein refers to monovalent (“aryl”) and divalent (“arylene”) single, polynuclear, conjugated or fused residues of aromatic hydrocarbons having from 6 to 10 carbon atoms. Such groups include, for example, phenyl, biphenyl, naphthyl, phenanthrenyl, and the like. Aryl groups may be optionally substituted.

As used herein, the term “heteroaryl” as used herein refers to an aromatic monocyclic or multicyclic ring system comprising about 5 to about 14 ring atoms, preferably about 5 to about 10 ring atoms, in which one or more of the ring atoms is an element other than carbon, for example nitrogen, oxygen or sulfur, alone or in combination. “Heteroaryl” may also include a heteroaryl as defined above fused to an aryl as defined above. Non-limiting examples of suitable heteroaryls include pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl and the like. The term “heteroaryl” also refers to partially saturated heteroaryl moieties such as, for example, tetralydroisoquinolyl, tetrahydroquinolyl and the like. Heteroaryl groups may be optionally substituted.

The term “carbocycle”, or variants such as “carbocyclic ring” as used herein, includes within its meaning any stable 3, 4, 5, 6, or 7-membered monocyclic or bicyclic or 7, 8, 9, 10, 11, 12, or 13-membered bicyclic or tricyclic, any of which may be saturated, partially unsaturated- or aronatic. The term “carbocycle” includes within its meaning cycloalkyl, cycloalkenyl and aryl groups. Examples of such carbocycles include, but are not limited to, cyclopropyl, cyclobutyl, cyclopentyl, cyclohexyl, cycioheptyl, adamantyl, cyclooctyl, [3.3.0]bicyclooctane, [4.3.0]bicyclononane, [4.4.0]bicyclodecane (decalin), [2222]bicyclooctane, fluorenyl, phenyl, naphthyl, indanyl, adamantyl, or tetrahydronaphthyl (tetralin). Preferred carbocycles, unless otherwise specified, are cyclopropyl, cyclobutyl, cyclopentyl, cyclohexyl, phenyl, naphthyl, and indanyl. Carbocycles may be optionally substituted.

The term “alkoxy” as used herein refers to an alkyl group singularly bonded to oxygen.

As used herein, the term “epoxide” refers to a three-membered ring or cyclic ring involving an oxygen atom and two carbon atoms.

The term “optionally substituted” as used herein means the group to which this term refers may be unsubstituted, or may be substituted with one, two, three or more groups other than hydrogen provided that the indicated atom's normal valency is not exceeded, and that the substitution results in a stable compound. Such groups may be, for example, halogen, hydroxy, oxo, cyano, nitro, alkyl, alkoxy, haloalkyl, haloalkoxy, aryl alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alklsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl4 alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of Rₓ and R^{Y} is independently selected from hydrogen or alkyl, or where appropriate WRY forms part of carbocylic or heterocyclic ring and m is 0, 1, 2, 3 or 4), a group R^{x}NR^{y}N(CH₂)ₚ— or R^{x}R^{y}N(CHI₂)ₚO (wherein p is 1, 2, 3 or 4); wherein when the substituent is R^{x}R^{y}N(CH₂)^{p}— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

As used herein, the term “polymer” refers to a large compound comprising of many smaller repeating units, also known as monomers. For example, the term polymer includes, but is not limited to, synthetic polymers such as plastics, resins, polystyrene, rubber, Teflon, polyethylene, nylon, neoprene polycarbonate and polyurethane.

The term “elastomer” as used herein means any polymer with elastic properties.

As used herein, the term “self-healing” means the built-in ability of the material to automatically heal or repair damages to themselves without any external help or human intervention.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 depicts the polymer network present in coatings of the present invention.

FIG. 2 shows the mechanism of self-healing in a coating of the invention.

FIG. 3 shows microscope profilemeter test images (a) after a scratch on a substrate coated with a coating of the invention, and (b) after it has healed.

FIG. 4 shows a comparison of an anti-corrosion salt spray test after a scratch on (a) a substrate coated with a non-self-healing layer and (b) a substrate coated with a coating of the invention.

FIG. 5 shows microscopic images of a corrosion observed for (a) a metal substrate without the coating of the present invention; and (b) a metal substrate with the coating of the present invention.

FIG. 6 shows a comparison of a scratch image and microscope profilemeter test, immediately after a scratch and 24 hours later, on a substrate coated with a coating of the present invention.

FIG. 7A (chart) and FIG. 7B (bar graph) show Electrochemical Impedance Spectroscopy (EIS) results of three samples: control unscratched, control scratched, and a sample coated with a coating of the present invention.

FIG. 8 is a Fourier transform infrared spectra (FTIR) showing that isocyanate groups are present in polyurethane but are not present in the polyurethane-boronic ester (PU-BE) network.

### DETAILED DESCRIPTION OF DRAWINGS

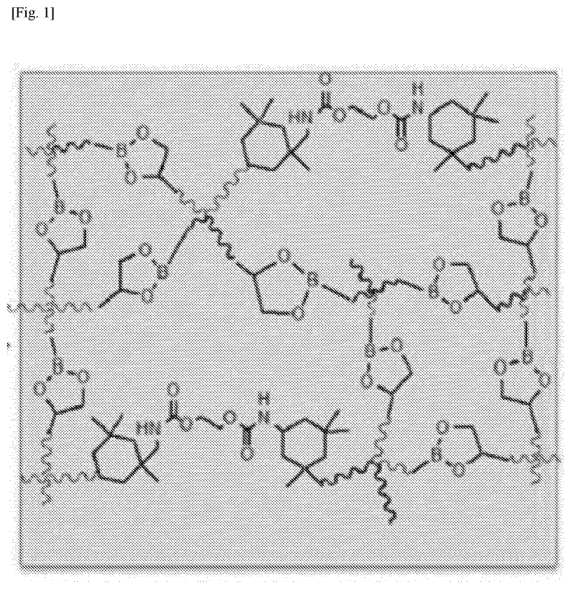

Referring to FIG. 1, FIG. 1 depicts the network present in the coatings of the present invention. The polymer network is a blend of a polyurethane (PU) and a boronic ester (BE), and is a combination of an interpenetrating polymer network (IPN) and a semi-interpenetrating polymer network (SIPN) where there is some covalent bonding between the boronic ester and the polyurethane.

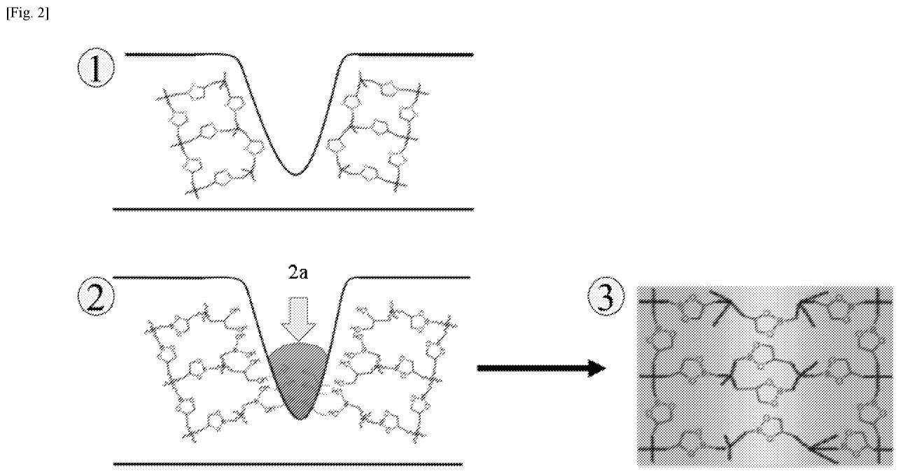

Referring to FIG. 2, FIG. 2 shows the mechanism of self-healing in a coating of the invention. A gap or crack may damage the boronic ester network as shown in (1). The gap or crack causes a break between the linkages between the boronic esters. As shown in (2), in the presence of moisture (2a), hydrolysis of the boronic esters located at the edges of the crack occur, exposing free hydoxyl groups. Re-esterification of free hydroxyl groups occur to reform the boronic esters groups, thereby closing the crack (3). The intrinsic self-healing property of the boronic ester polymer network relies on the reversible chemistry of a boronic acid group and a diol group to form a boronic ester and the presence of moisture in the environment. Hydrolysis on the surface, followed by esterification, occurs to self-repair the coating. Advantageously, the self-healing mechanism is not a once-off healing mechanism. This reversible chemistry will enable the coating to repair by itself.

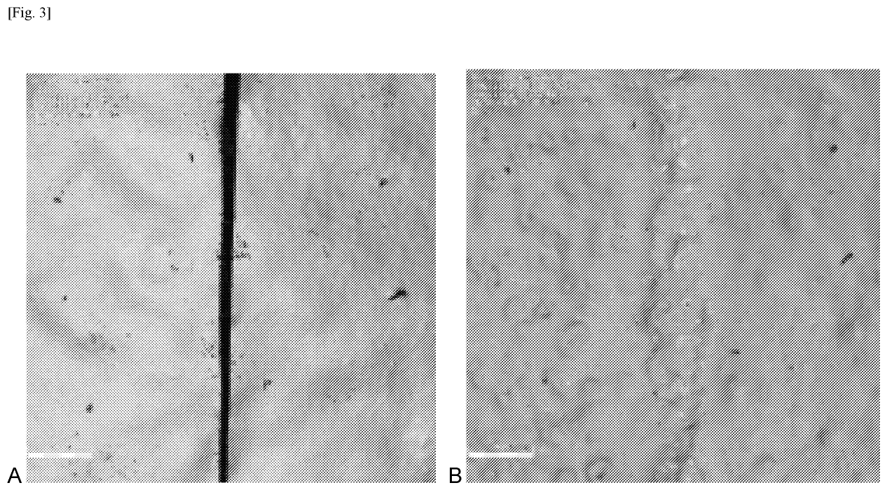

The coatings used in FIGS. 3 to 5 comprise boronic ester and polyurethane in a ratio of 1:1:

FIG. 3 shows microscope profilemeter test images of a scratch on a substrate coated with a coating of the invention: (A) immediately after a scratch, and (B) 48 hours later. As shown in FIG. 3B, the depth of the scratch is decreased substantially and the edges of the scratch are sealed, evidencing the self-healing mechanism of the present invention.

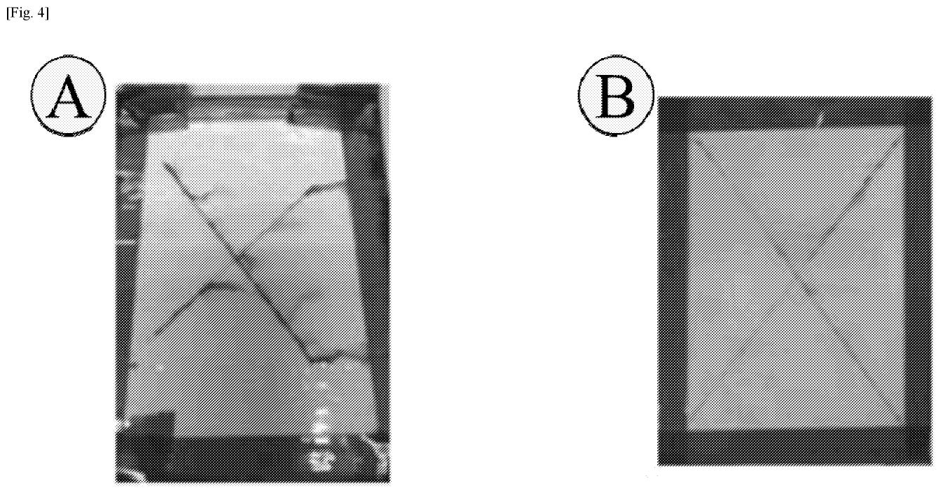

Similarly, FIG. 4 shows a comparison of an anti-corrosion salt spray test after a scratch on (a) a substrate coated with a non-self-healing layer and (b) a substrate coated with a coating of the invention. As shown in FIG. 4, the substrate coating with a coating of the invention exhibits significantly less corrosion.

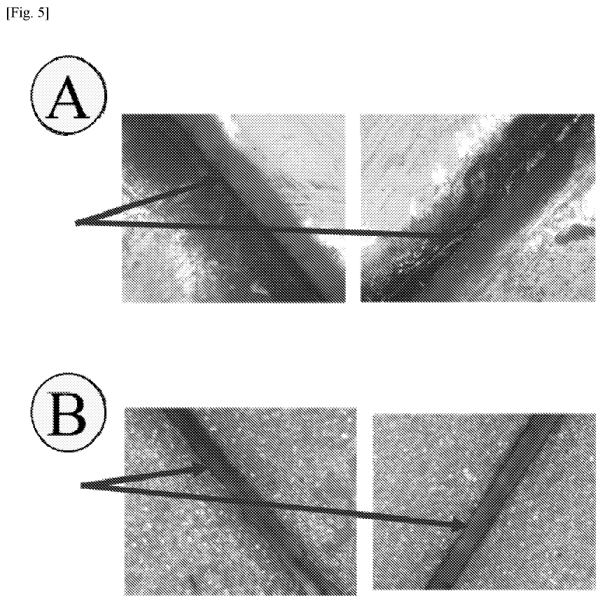

FIG. 5 shows the microscopic images of the corrosion observed for (A) a metal substrate with no self-healing coating and (B) a metal substrate with 50% BE -50% PU self-healing coating. With no self-healing layer coated on the metal substrate, FIG. 5A shows a deep corroded line on the edges of the metal substrate and the deep and big creepage resulting from the corrosion. On the other hand, FIG. 5B shows that the metal substrate is coated with the 50% BE -50% PU self-healing coating along the corroded line to further prevent corrosion from happening.

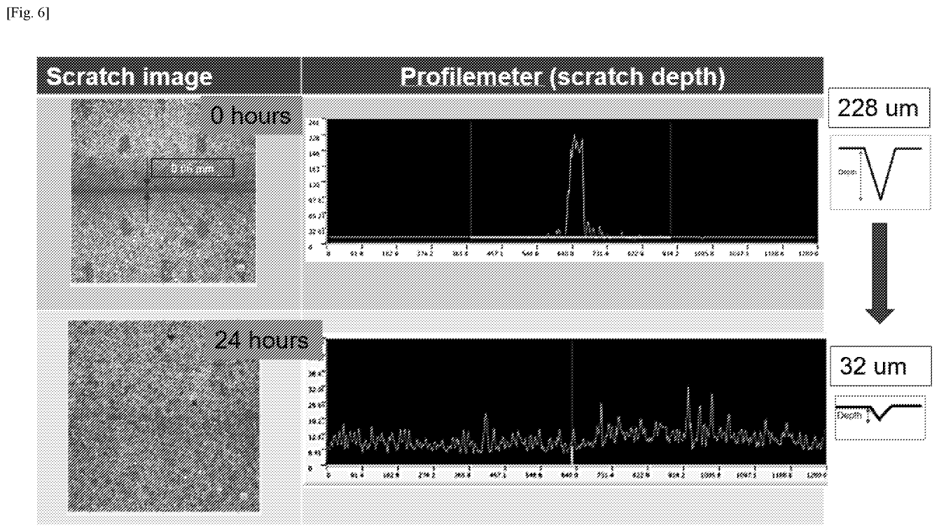

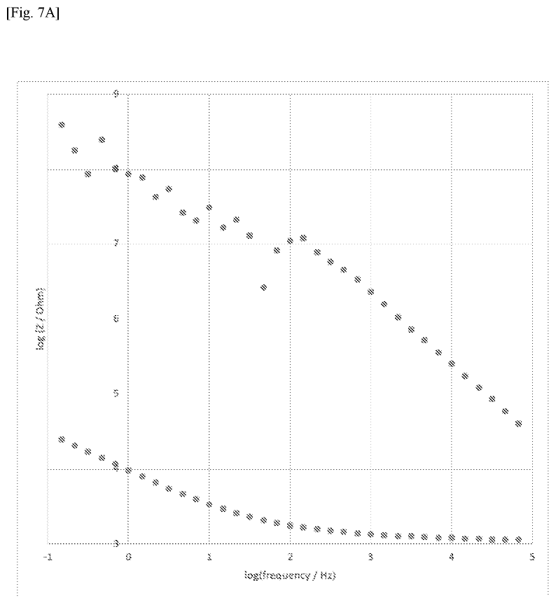

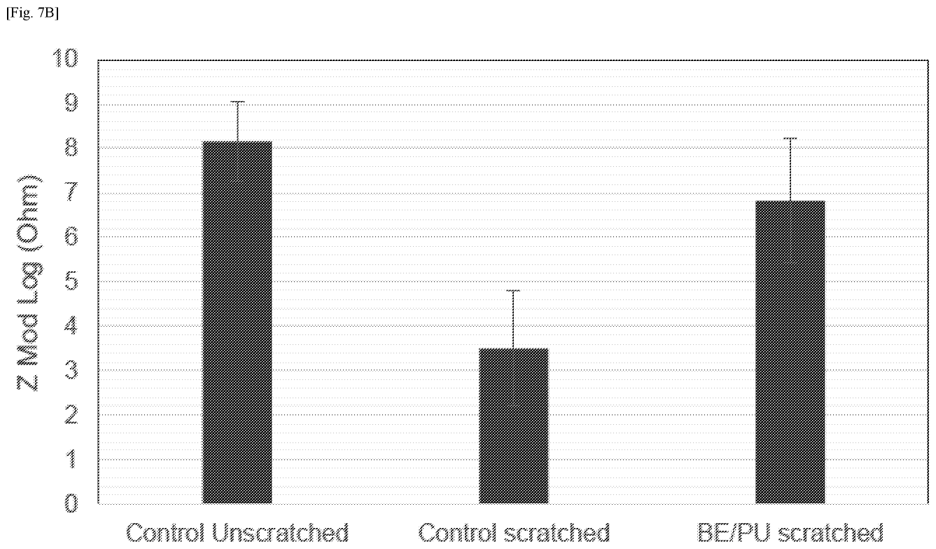

FIG. 6 shows the scratch image, microscope profilemeter test and the calculated depth immediately (0 hours) after a scratch on a substrate coated with a self-healing layer of the present invention; and 24 hours after the scratch. FIG. 6 shows that the depth of the scratched surface changes from 228 μm to 32 μm as the coating self-healed, filling the crack/gap formed by the scratch.

### DETAILED DISCLOSURE OF EMBODIMENTS

This present invention seeks to provide a self-healing coating composition comprising a boronic ester and a polymer. The invention also seeks to provide a protective anti-corrosive coating for the oil and gas industry where it allows timely and effective repair to the metal substrates and prevent rapid intake of corrosive media and premature coating failure.

The present invention relates to a coating composition of good durability, form, and stability, suited for the harsh off-shore conditions (e.g. high temperature and humidity) experienced in the oil and gas industry. It not only act as a protective coating for corrosion, but also exhibit excellent healing, possess high durability and enhanced mechanical strength and rigidity. This advantageously increases the lifespan of metal infrastructures and lower maintenance cost and reduce labour.

In one aspect, the present disclosure relates to a coating comprising:
(i) a compound of Formula (I):

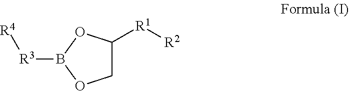

wherein:
R¹ is an optionally substituted alkylene bridge of C₁ to C₁₂ carbon atoms where one or more carbon atoms can be replaced by O, N or S;
R² is alkene or epoxide;
R³ is optionally substituted aryl, optionally substituted heteroaryl or optionally substituted carbocyclyl; and
R⁴ is alkene, epoxide, —R⁵-alkene or —R⁵-epoxide, wherein R⁵ is an optionally substituted alkylene bridge of C₁ to C₁₂ carbon atoms where one or more carbon atoms can be replaced by O, N or S;
(ii) an elastomer;
wherein (i) and (ii) are cured with pentaerythritol tetrakis(3-mercaptoptopionate) (PTMP) and 3,6-dioxa-1,8-octanedithiol (DODT).

Advantageously, the elastomer may possess high elasticity and its presence in the coating may provide an additional healing (on top of the disclosed chemistry-based healing mechanism) through a viscoelastic “spring back” of the scratches or cracks to further improve healing.

The addition of an elastomer to the boronic ester in the disclosed coating provides a synergistic effect through a simple and convenient polymer network. The polymer network is a blend of elastomer and boronic ester of formula (I), and is a combination of an interpenetrating polymer network (IPN) or a semi-interpenetrating polymer network (SIPN) where there is some covalent bonding between the boronic ester and the elastomer. This balance between the elastomer and the boronic ester and covalent versus non-covalent contributes to the optimized balance of mechanical and thermal properties with healing properties. The coatings display excellent self-healing, enhanced mechanical strength and rigidity, and better durability. The coating composition acts as a protective layer for corrosion and gives metal infrastructures a longer lifespan.

The elastomer may be selected from the group consisting of polyisobutylene, polyurethane, polysiloxane, polybutadiene, saturated rubber, unsaturated rubber, and thermoplastic elastomer.

The elastomer may be a polyurethane wherein the polyurethane comprises or consists of the reaction product of:
i. a cyclic aliphatic isocyanate or cyclic aliphatic diisocyanate;
ii. a polyol; and
iii. a chain extender.

Advantageously, polyurethanes synthesized from carbocyclic rings have higher elasticity compared to polyurethanes synthesized from aromatic isocyanates (e.g. methylene diphenyl diisocyanate (MDI)) or straight chain aliphatic isocyanates (e.g. hexamethylene diisocyanate (HDI)). Advantageously, the high elasticity of polyurethanes synthesized from cyclic aliphatic isocyanates or cyclic aliphatic diisocyanates provide an additional healing (on top of the disclosed chemistry-based healing mechanism) through a viscoelastic “spring back” of the scratches or cracks to further improve healing.

The polyurethane may be synthesized from cyclic aliphatic diisocyanate. The cyclic aliphatic diisocyanate may be selected from the group consisting of 4,4′-methylenebis (cyclohexylisocyanate), isophorone diisocyanate, methylcyclohexane-2,4-diiso-cyanate, methylcyclohexane-2,6-diisocyanate, cyclohexane-1,4-diisocyanate, hexahydroxylylene diisocyanate, and octahydro-1,5-naphthalene diisocyanate.

The polyol may be selected from the group consisting poly(ethyleneglycol), poly(propyleneglycol), poly(tetrahydrofuran), and combinations thereof.

The polyol may have a molecular weight of about 400 g/mol to about 1500 g/mol. The polyol may have a molecular weight of about 400 g/mol to about 1500 g/mol, about 450 g/mol to about 1500 g/mol, about 500 g/mol to about 1500 g/mol, about 550 g/mol to about 1500 g/mol, about 600 g/mol to about 1500 g/mol, about 650 g/mol to about 1500 g/mol, about 700 g/mol to about 1500 g/mol, about 750 g/mol to about 1500 g/mol, about 800 g/mol to about 1500 g/mol, about 850 g/mol to about 1500 g/mol, about 900 g/mol to about 1500 g/mol, about 950 g/mol to about 1500 g/mol, about 1000 g/mol to about 1500 g/mol, about 1050 g/mol to about 1500 g/mol, about 1100 g/mol to about 1500 g/mol, about 1150 g/mol to about 1500 g/mol, about 1200 g/mol to about 1500 g/mol, about 1250 g/mol to about 1500 g/mol, about 1300 g/mol to about 1500 g/mol, about 1350 g/mol to about 1500 g/mol, about 1400 g/mol to about 1500 g/mol, about 1450 g/mol to about 1500 g/mol, about 400 g/mol to about 1450 g/mol, about 400 g/mol to about 1400 g/mol, about 400 g/mol to about 1350 g/mol, about 400 g/mol to about 1300 g/mol, about 400 g/mol to about 1250 g/mol, about 400 g/mol to about 1200 g/mol, about 400 g/mol to about 1150 g/mol, about 400 g/mol to about 1100 g/mol, about 400 g/mol to about 1050 g/mol, about 400 g/mol to about 1000 g/mol, about 400 g/mol to about 950 g/mol, about 400 g/mol to about 900 g/mol, about 400 g/mol to about 850 g/mol, about 400 g/mol to about 800 g/mol, about 400 g/mol to about 750 g/mol, about 400 g/mol to about 700 g/mol, about 400 g/mol to about 650 g/mol, about 400 g/mol to about 600 g/mol, about 400 g/mol to about 550 g/mol, about 400 g/mol to about 500 g/mol, about 400 g/mol to about 450 g/mol, or about 400 g/mol, about 425 g/mol, about 450 g/mol, about 475 g/mol, about 500 g/mol, about 525 g/mol, about 550 g/mol, about 575 g/mol, about 600 g/mol, about 625 g/mol, about 650 g/mol, about 675 g/mol, about 700 g/mol, about 725 g/mol, about 750 g/mol, about 775 g/mol, about 800 g/mol, about 825 g/mol, about 850 g/mol, about 875 g/mol, about 900 g/mol, about 925 g/mol, about 950 g/mol, about 975 g/mol, about 1000 g/mol, about 1025 g/mol, about 1050 g/mol, about 1075 g/mol, about 1100 g/mol, about 1125 g/mol, about 1150 g/mol, about 1175 g/mol, about 1200 g/mol, about 1225 g/mol, about 1250 g/mol, about 1275 g/mol, about 1300 g/mol, about 1325 g/mol, about 1350 g/mol, about 1375 g/mol, about 1400 g/mol, about 1425 g/mol, about 1450 g/mol, about 1475 g/mol, about 1500 g/mol, or any value or range therebetween.

The chain extender may be of the general formula HO—(CH₂)ₙ-OH, wherein n is an integer of 2 to 5. n may be 2, 3, 4, or 5.

The polyurethane may comprise or consist of repeating units of Formula (IIA) or (IIIA):

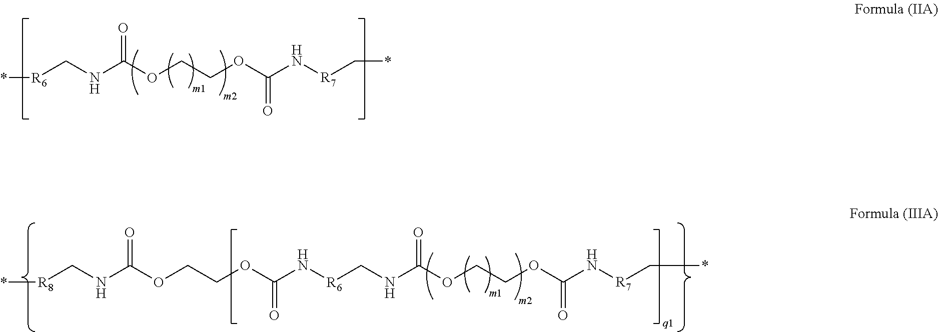

wherein R₆, R₇ and R₈ are optionally substituted cycloalkyl groups;
m1 is an integer of 1 to 3;
m2 is an integer greater than 1, preferably an integer of 4 to 20;
q1 is an integer greater than 1.
   R₆, R₇ and R₈ may independently be selected from optionally substituted cyclopropyl, cyclobutyl, cyclopentyl, or cyclohexyl. R₆, R₇ and R₈ may be independently substituted with one or more alkyl groups, such as methyl, ethyl, and propyl.
   m1 may be an integer of 1, 2 or 3. m2 may be an integer of 2, 3, 4, 5, 6, 7, 8, 9, 10, 11, 12, 13, 14, 15, 16, 17, 18, 19, 20, 21, 22, 23, 24, or 25.

The polyurethane may comprise or consist of repeating units of Formula (JIB) or (IIIB):

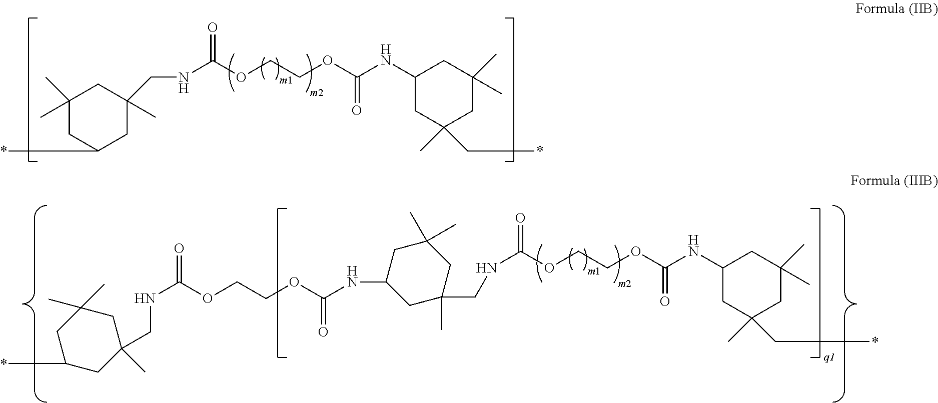

wherein m1 is an integer of 1 to 3;
m2 is an integer greater than 1, preferably an integer of 4 to 20; and
q1 is an integer greater than 1.

The polyurethane may be of Formula (IV):

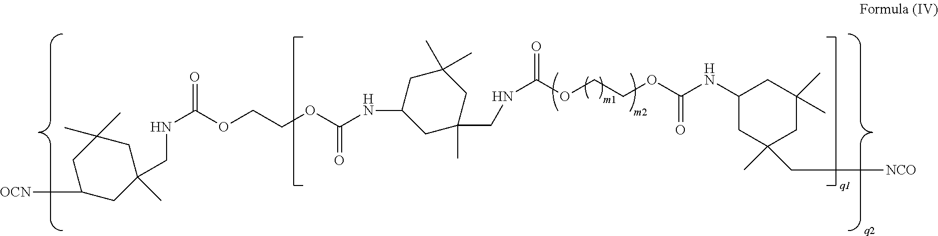

wherein
m1 is 3;
m2 is an integer greater than 1, preferably an integer of 4 to 20;
q1 is an integer greater than 1; and
q2 is an integer greater than 1.

In a compound of Formula (I), R³ may be an optionally substituted C₆ to C₁₀ aryl. R³ may be C₆, C₇, C₈, C₉, or C₁₀ aryl.

In a compound of Formula (I), R¹ may be an optionally substituted alkylene bridge of C₁ to C₆ carbon atoms where one or more carbon atoms can be replaced by O and R² is C₂ alkene. The alkylene bridge have C₁, C₂, C₃, C₄, C₅, or C₆ carbon atoms where one or more carbon atoms can be replaced by O.

In a compound of Formula (I), R¹ may be an optionally substituted alkylene bridge of C₁ to C₆ carbon atoms where one or more carbon atoms can be replaced by O and R² is epoxide. The alkylene bridge have C₁, C₂, C₃, C₄, C₅, or C₆ carbon atoms where one or more carbon atoms can be replaced by O.

In a compound of Formula (I), —R¹-R² may be —(CH₂)ₚO—(CH₂)_{q}(CH═CH₂) or —(CH₂)ₚ-epoxide, wherein p and q are independently an integer of 1 to 6. “p” and “q” may be independently 1, 2, 3, 4, 5, or 6.

In a compound of Formula (I), —R³—R⁴ may be -phenyl-alkene or -phenyl-epoxide.

A compound of Formula (I) may be selected from the following compounds:

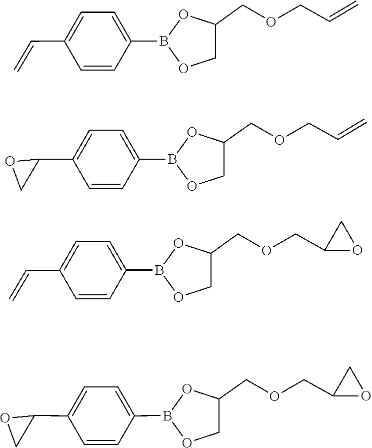

The coating may comprise:
(i) a compound selected from the group consisting of the following compounds:

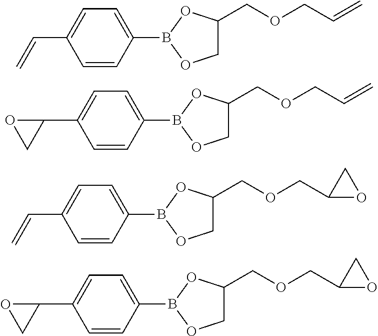

(ii) a polyurethane, wherein the polyurethane comprises a reaction product of:
   a. a cyclic aliphatic isocyanate or cyclic aliphatic diisocyanate;
   b. a polyol; and
c. a chain extender;
wherein (i) and (ii) are cured with pentaerythritol tetrakis(3-mercaptoptopionate) (PTMP) and 3,6-dioxa-1,8-octanedithiol (DODT).

The coating may comprise:
(i) a compound selected from the group consisting of the following compounds:

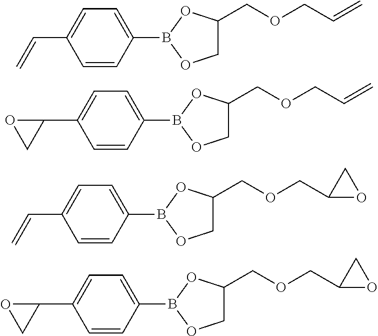

(ii) a polyurethane, wherein the polyurethane comprises repeating units of Formula (IIA) or (IIIA):

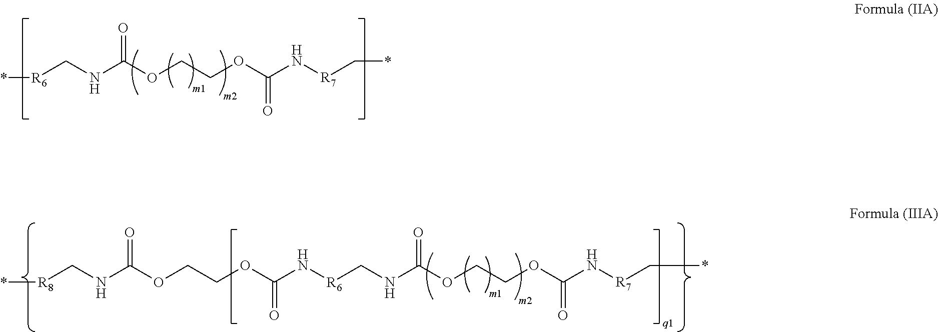

wherein R₆, R₇ and R₈ are optionally substituted cycloalkyl groups;
m1 is an integer of 1 to 3;
m2 is an integer greater than 1, preferably an integer of 4 to 20;
q1 is an integer greater than 1;
wherein (i) and (ii) are cured with pentaerythritol tetrakis(3-mercaptoptopionate) (PTMP) and 3,6-dioxa-1,8-octanedithiol (DODT).

The coating may comprise:
(i) a compound selected from the group consisting of the following compounds:

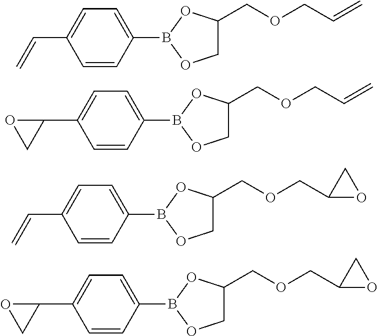

(ii) a polyurethane, wherein the polyurethane comprises repeating units of Formula (IIB) or (IIIB):

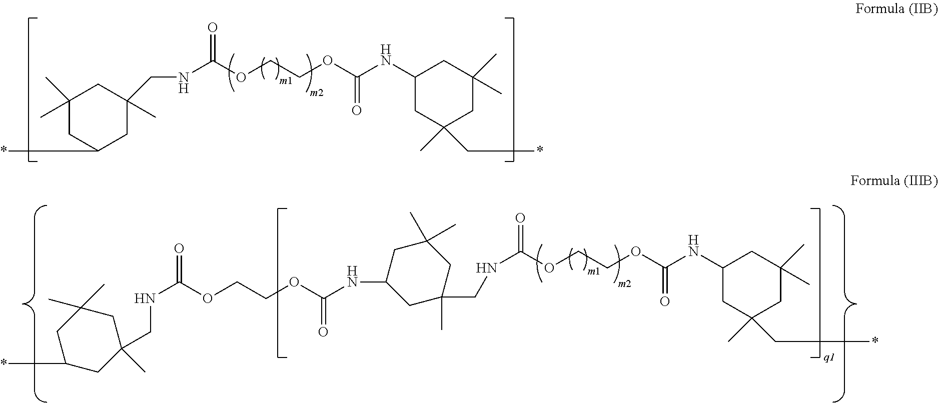

wherein m1 is an integer of 1 to 3;
m2 is an integer greater than 1, preferably an integer of 4 to 20; and
q1 is an integer greater than 1;
wherein (i) and (ii) are cured with pentaerythritol tetrakis(3-mercaptoptopionate) (PTMP) and 3,6-dioxa-1,8-octanedithiol (DODT).

The coating may comprise:
(i) a compound selected from the group consisting of the following compounds:

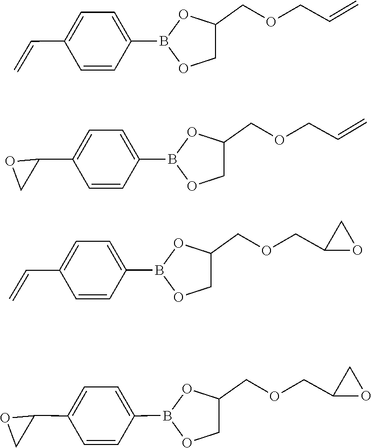

(ii) a polyurethane, wherein the polyurethane is of Formula (IV):

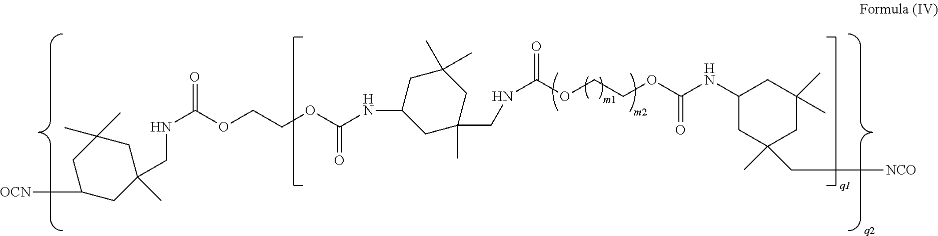

wherein m1 is 3;
m2 is an integer greater than 1, preferably an integer of 4 to 20;
q1 is an integer greater than 1; and
q2 is an integer greater than 1;
wherein (i) and (ii) are cured with pentaerythritol tetrakis(3-mercaptoptopionate) (PTMP) and 3,6-dioxa-1,8-octanedithiol (DODT).

In the coating, the ratio of the compound of Formula (I) to the elastomer may be in the range of 4:1 to 1:4, preferably 1:1.

The coating may be capable of acting as a self-healing agent in the presence of moisture. The moisture may be atmospheric moisture.

The present disclosure also relates to a method of self-healing cracks that can form in the coating, wherein said crack is exposed to moisture thereby inducing esterification between hydroxy groups located on either side of said crack, thereby at least partially bonding the edges of said crack together. The edges of the crack may bonded together by at least 80%. The moisture may be atmospheric moisture. The method may be performed at room temperature.

The present disclosure also relates to a pipeline or any substrate comprising the coating.

The present disclosure also relates to a method for synthesizing the coating comprising:
(a) preparing a mixture comprising a compound of Formula (I) of claim 1, pentaerythritol tetrakis (3-mercaptoptopionate) (PTMP), 3,6-dioxa-1,8-octanedithiol (DODT), elastomer and photoinitiator; and
(b) curing the mixture of step (a).

Step (b) may comprise thermal curing, redox curing or UV curing.

Step (b) may comprise irradiating the mixture under ultraviolet (UV) light for at least 10 minutes. The mixture may be irradiated for at least about 10 minutes, about 15 minutes, about 20 minutes, about 25 minutes, about 30 minutes, about 35 minutes, about 40 minutes, about 45 minutes, about 50 minutes, about 55 minutes, about 60 minutes, or any value or range therebetween.

The method may also further comprise:
(c) drying the product of step (b) for at least one day.

The disclosed coating composition comprising boronic ester and polyurethane may form an interpenetrating polymer network (IPN) or semi-interpenetrating polymer network (SIPN). IPN forms a crosslinked structure where the polymers are at least partially interlaced on a molecular scale but not necessarily covalently bonded to each other and cannot be separated unless chemical bonds are broken. The key distinguishing factor of an SIPN is at least one of the polymers of the crosslinked network has a linear or branched structure and it can be removed or separated from the network without breaking any chemical bonds. With the addition of an elastic polymer such as polyurethane to boronic ester compound in the coating composition, it forms the IPN or SIPN structure, and ultimately provides enhanced strength, rigidity and durability to the coating composition.

The use of the disclosed coating composition for anti-corrosion applications and protective coatings in the oil and gas industry. The disclosed coating composition protects the metal substrate from corrosion by a self-healing mechanism.

The intrinsic self-healing property of the disclosed coating composition is built upon the reversible chemistry of a boronic acid group and a diol group to form a boronic ester diene. When the coating is damaged, water or atmospheric moisture present in the crack will trigger hydrolysis, followed by esterification, to form a boronic ester. It is not a once-off healing mechanism. This reversible chemistry will enable the coating to repair by itself every time and can undergo in humid condition at room temperature to regenerate the inter-penetrating or semi-interpenetrating polymer network.

In the present disclosure, there is a metal substrate coated with the disclosed coating composition. This coated metal substrate with self-healing property may allow for timely and effective repair to the metal substrate and prevent rapid intake of corrosive media and premature coating failure. This protects the metal substrate from corrosion and gives oil and gas infrastructures a relatively longer lifespan.

### EXAMPLES

Non-limiting examples of the invention and a comparative example will be further described in greater detail by reference to specific Examples, which should not be construed as in any way limiting the scope of the invention.

Materials

Pentaerythritol tetrakis(3-mercaptoptopionate) (PTMP) (>95%) was obtained from Sigma Aldrich.

3,6-dioxa-1,8-octanedithiol (DODT) (95%) was obtained from Sigma Aldrich.

2,2-dimethoxy-2-phenylacetophenone (DMPA) (99%) was obtained from Sigma Aldrich.

Vinylphenylboronic acid (>95%) was obtained from Boron Molecular Pty Limited.

Poly(tetrahydrofuran) (PTHF) (MW=650) was obtained from Sigma Aldrich.

Isophorone diisocyanate (IPDI, 98%) was obtained from Sigma Aldrich.

### Example 1a: Preparation of Boronic Ester with Diene Functional Groups

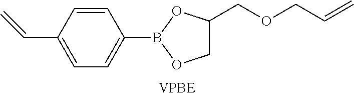 [SMILES: C=CCOCC1COB(c2ccc(C=C)cc2)O1]

4-(allyloxy)methyl)-2-(4-vinylphenyl-1,3,2-dioxaborlane (VPBE) was prepared as follows. In a beaker, 4-vinylphenylboronic acid (48.8 g, 330 mmol) and 3-allyloxy-1,2-propanediol (39.6 g, 300 mmol) were stirred in dry dichloromethane (400 mL) in a flat bottom flask, with molecular sieves (4 Å, 50 g) for 12 hours at room temperature. Molecular sieves (drying agent) were added to remove water in the solution and thus drive the reaction to completion. The solution was then filtered and concentrated to obtain a colorless to pale-yellow liquid. The yield is about 85%.

### Example 1b: Preparation of Boronic Ester with Epoxy Functional Groups

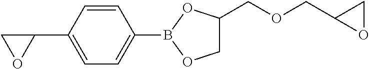 [SMILES: c1cc(C2CO2)ccc1B1OCC(COCC2CO2)O1]

4 methyl glycidyl ether 2 phenyl oxirane dioxaborolane was prepared as follows. 4-(allyloxy)methyl)-2-(4-vinylphenyl-1,3,2-dioxaborlane (VPBE, 2.45 grams, 0.01 mol) from Example 1a, and 10 mL dichloromethane (DCM) were added in to a 2 neck round bottle flask with mechanical stirrer and N₂. The flask was placed in a water-ice bath and meta-Chloroperoxybenzoic acid (m-CPBA, 2.59 grams, 0.015 mol) was slowly added in three times. After the completion of m-CPBA, the reaction was kept at around 0 C for 4 hours. After that, the flask was warmed to room temperature and kept for 8 hours. The mixture was filtered. The filtrate was washed by saturated sodium thiosulfate solution followed by sodium bicarbonate solution and dried with anhydrous sodium sulfate. The final product was obtained after the removal of solvent.

### Example 2: Preparation of Polyurethane

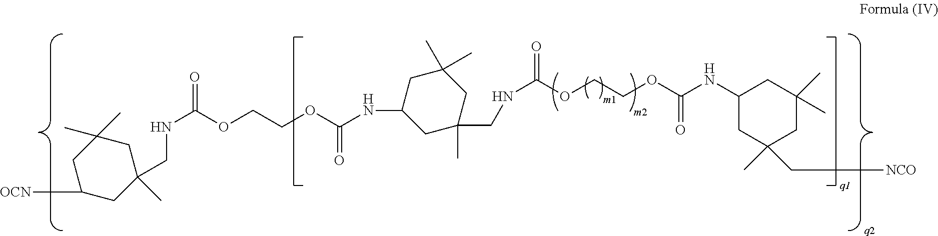

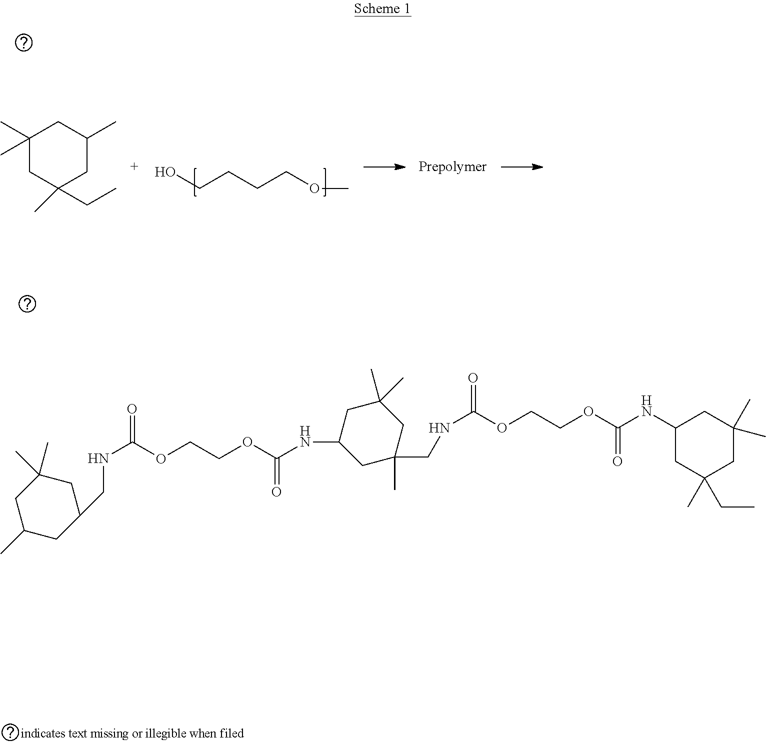

Polyurethane of Formula (IV) was synthesized through two steps. First, a bis-isocyanate terminated pre-oligomer was synthesized by reacting poly(tetrahydrofuran) (PTHF) (as a soft segment diol) with isophorone diisocyanate (IPDI) in DMF in the presence of dibutyltin dilaurate as a catalyst. Ethylene glycol (EG) was added to the solution as a chain extender to complete the synthesis.

DMF was used as the solvent and dried with molecular sieves 4A prior to the removal of any water. The ratio of isocyanate to hydroxy group can be varied from 1.05 to 1.5. PTHF:EG=1:1.

PTHF (9.425 g, 14.5 mmol) in a dried glass vessel equipped with a mechanical stirrer was heated in an oil bath at ˜100° C. under vacuum for 1.5 hours to remove any moisture and then cooled to 70° C. Varying amounts of isophorone diisocyanate (IPDI) based on isocyanate to hydroxyl group ratio and dibutyltin dilaurate (DBTDL, 2000 ppm) dissolved in DMF (15 mL) were added dropwise into the vessel (over 30 minutes). After 2 hours of stirring under a nitrogen atmosphere, ethylene glycol was added (0.899 g, 14.5 mmol) in 15 ml DMF then stirred for 2 hours.

### Example 3: Preparation of the Coating Composition

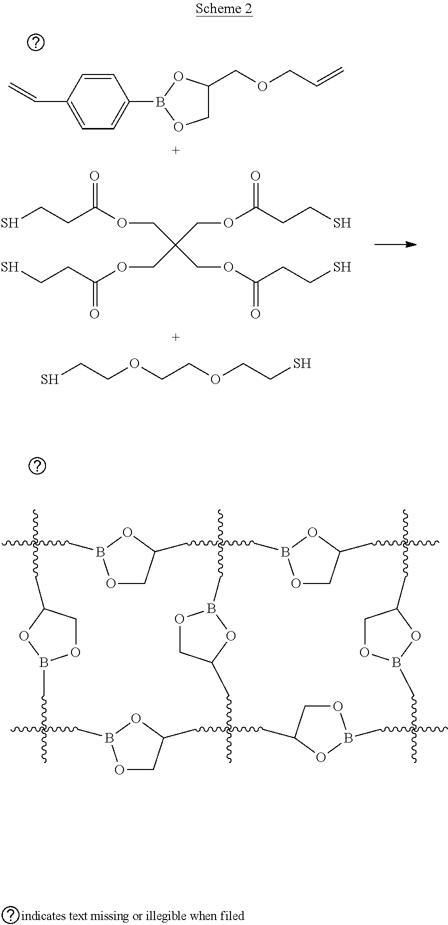

With reference to Scheme 2, a mixture comprising 4-((allyloxy)methyl)-2-(4-vinylphenyl)-1,3,2-dioxaborlane (VPBE), pentaerythritol tetrakis(3-mercaptoptopionate) (PTMP) and 3,6-dioxa-1,8-octanedithiol (DODT) with determined weight (molar ratio of VPBE:thiol=1:1, DODT:PTMP: 50:50) and a photoinitiator, 2,2-dimethoxy-2-phenylacetophenone (DMPA, 1 wt %) was prepared. The amounts of reactants used are shown in Table 1.

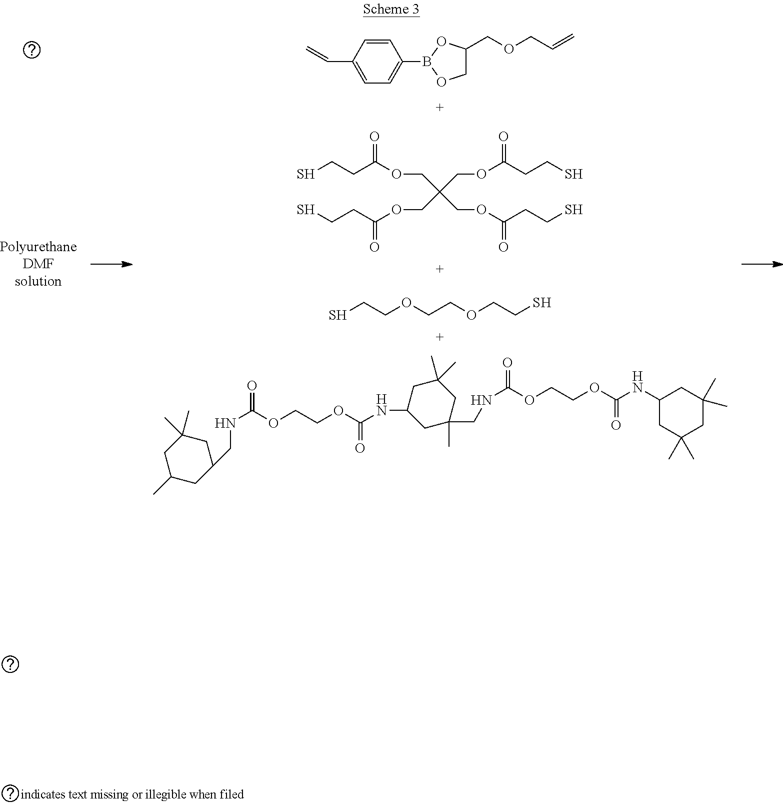

The mixture was mixed and stirred for a few minutes to dissolve DMPA, then 20%, 30%, 40%, 50%, or 80% of the polyurethane prepared by Example 2 was added. The solution was then cast in a silicon mould, carbon steel and glass slide, and cured for 1 hour under a UV light or Suntester (350 W/m², 300 nm-800 nm). The sample was then dried in air at room temperature for at least 2 days. The polymer network is a blend of a polyurethane (PU) and a boronis ester (BE), and is a combination of an interpenetrating polymer network (IPN) and a semi-interpenetrating polymer network (SIPN) where there is some covalent bonding between the boronic ester and the polyurethane. The network comprises a thiol-isocyanate-ene ternary network which is formed via a thiol-isocyanate click reaction between PTMP, DODT and polyurethane.

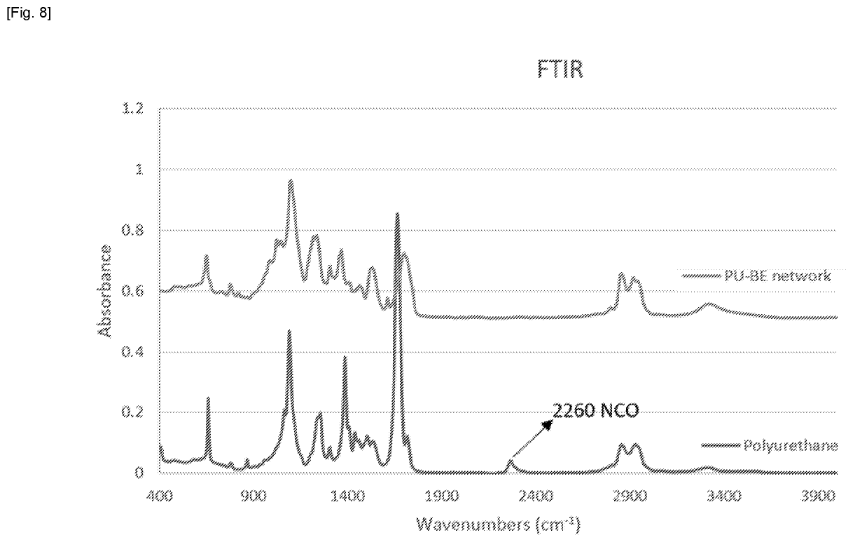

The end groups of synthesized polyurethane are isocyanates. The thiol-isocyanate and thiol-ene react through click chemistry, and when polyurethane, VPBE, PTMP and DODT are mixed together with an initiator, a thiol-isocyanate-ene ternary network is obtained. With reference to FIG. 8, the FTIR shows that there are some isocyanate groups (2200 cm⁻¹) in polyurethane, while the polyurethane-boronic ester network do not contain isocyanate groups. This indicates that the isocyanate groups are reacted to form the network.

TABLE 1

| | Amount of Reactants/Reagents Required (g) | | | |
|---|---|---|---|---|
| Coating | Boronic | Polyurethane | | |
| composition of | Ester (BE, | (PU, Polymer, | | |
| BE and PU in | compound | 37wt % in a | | |
| the weight ratio | of Formula | solvent (such as | | |
| of X:Y | (I)) | DMF or xylene) | DODT | PTMP |
| 80:20 | 2 | 2.53 | 0.747 | 1 |
| 70:30 | 2 | 4.34 | 0.747 | 1 |
| 60:40 | 2 | 6.75 | 0.747 | 1 |
| 50:50 | 2 | 10.12 | 0.747 | 1 |
| 20:80 | 2 | 40.51 | 0.747 | 1 |

### Example 4: Composition and Characteristics of BE:PU Coating

TABLE 2

| Coating | | | | |
|---|---|---|---|---|
| composition | | | | Strain at |
| of BE and | Healing | | Tensile | maximum |
| PU in the | efficiency | Adhesive | strength | load |
| ratio of X:Y | (%) | strength | (MPa) | (%) |
| Bare BE | 100 | — | 1.93 ± 0.41 | 51 ± 14 |
| 80:20 | 81 | — | 2.59 ± 1.0 | 215 ± 134 |
| 70:30 | 81 | — | 3.03 ± 1.05 | 496 ± 102 |
| 60:40 | 70 | — | 3.44 ± 0.14 | 600 ± 90 |
| 50:50 | 55 | 5.26 MPa | 4.26 ± 0.79 | 604 ± 77 |
| 20:80 | 21 | — | 11.2 ± 0.74 | 911 ± 54 |
| Bare PU | 0 | — | 21.8 ± 3.52 | 881 ± 79 |

As shown in Table 2 above, the bare boronic ester (BE) networks displays low mechanical properties, such as a tensile stress is less than 2 MPa). Further, they have poor adhesion and durability. This makes them unsuitable for real applications.

The inventors have surprisingly found that by adding an elastomer to the boronic ester network, such as polyurethane, the tensile strength improves significantly from 1.93 MPa to 4.26 MPa for the BE:PU=1:1 blend and is able to better withstand aggressive environments. In addition to the chemistry-based healing mechanism, the high elasticity imparted by the elastomer provides an additional healing through a viscoelastic “spring back of scratches or cracks” to further improve healing.

### INDUSTRIAL APPLICABILITY

The disclosed coating composition comprises a boronic ester and an elastomer. Advantageously, this combination of boronic ester and elastomer in the coating features a self-healing property. It is able to autonomously repair without any external help or human intervention. It not only act as a protective layer for corrosion, but also exhibit excellent healing, possess high durability and enhanced mechanical strength and rigidity.

Therefore advantageously, the disclosed coating composition may be stable, robust and durable under long-term exposure and harsh conditions experienced by the oil and gas industry and may be suitable for use as an anti-corrosive and self-healing coating for the oil and gas infrastructures.

The disclosed coating composition may be able to provide timely and effective repair to the coating to protect the metal substrate from further corrosion and damage. This advantageously results in longer lifespan of metal infrastructures and lower cost and labour for maintenance.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A coating comprising:
(i) a compound of Formula (I): 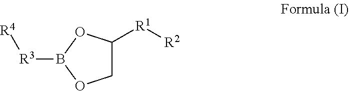
wherein:
R¹ is an optionally substituted alkylene bridge of C₁ to C₁₂ carbon atoms where one or more carbon atoms can be replaced by O, N or S;
R² is alkene or epoxide;
R³ is optionally substituted aryl, optionally substituted heteroaryl or optionally substituted carbocyclyl; and
R⁴ is alkene, epoxide, —R⁵-alkene or —R⁵-epoxide, wherein R⁵ is an optionally substituted alkylene bridge of C₁ to C₁₂ carbon atoms where one or more carbon atoms can be replaced by O, N or S; and
(ii) an elastomer;
wherein (i) and (ii) are cured with pentaerythritol tetrakis(3-mercaptoptopionate) (PTMP) and 3,6-dioxa-1,8-octanedithiol (DODT).

2. The coating of claim 1, wherein the elastomer is selected from the group consisting of polyisobutylene, polyurethane, polysiloxane, polybutadiene, saturated rubber, unsaturated rubber, and thermoplastic elastomer.

3. The coating of claim 1, wherein the elastomer is a polyurethane, wherein the polyurethane comprises a reaction product of:
i. a cyclic aliphatic isocyanate or cyclic aliphatic diisocyanate;
ii. a polyol; and
iii. a chain extender.

4. The coating of claim 3, wherein the cyclic aliphatic diisocyanate is selected from the group consisting of 4,4′-methylenebis (cyclohexylisocyanate), isophorone diisocyanate, methylcyclohexane-2,4-diiso-cyanate, methylcyclohexane-2,6-diisocyanate, cyclohexane-1,4-diisocyanate, hexahydroxylylene diisocyanate, and octahydro-1,5-naphthalene diisocyanate; or
wherein the polyol is selected from the group consisting of poly(ethyleneglycol), poly(propyleneglycol), poly(tetrahydrofuran), and combinations thereof, preferably,
wherein the polyol has a molecular weight of about 400 g/mol to about 1500 g/mol; or
wherein the chain extender is of the general formula HO—(CH2)n-OH, wherein n is an integer of 2 to 5.

5. (canceled)

6. (canceled)

7. (canceled)

8. The coating of claim 3, wherein the polyurethane comprises repeating units of formula (IIA) or (IIIA): 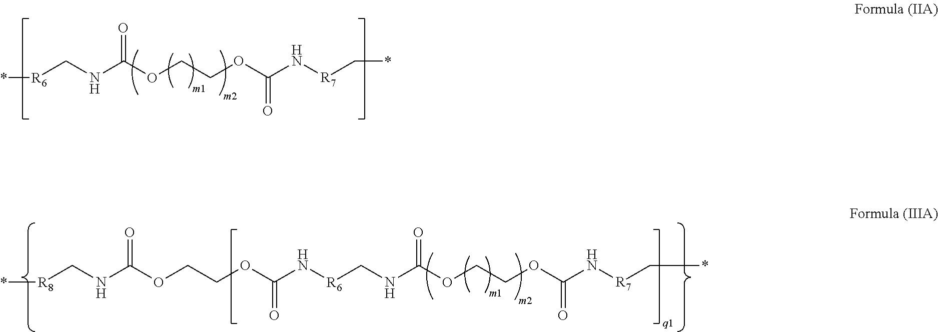
wherein R₆, R₇ and R₈ are independently optionally substituted carbocyclic groups or optionally substituted cyclohexyl;
m1 is an integer of 1 to 3;
m2 is an integer greater than 1; and
q1 is an integer greater than 1; or
wherein the polyurethane comprises repeating units of formula (IIB) or (IIIB): 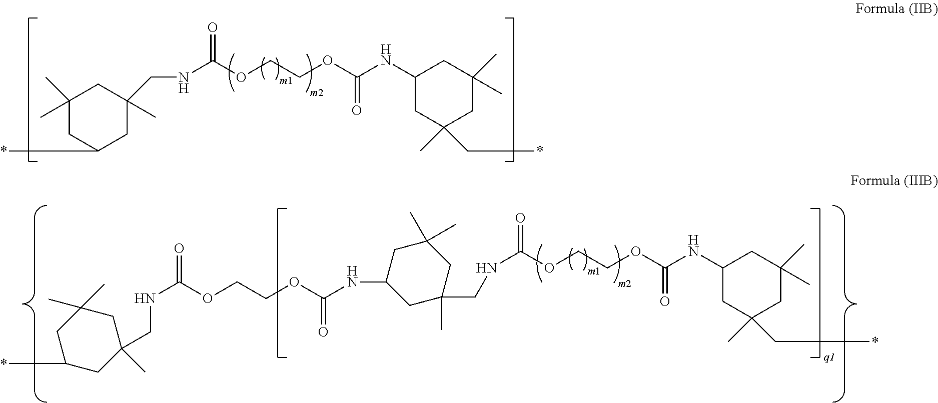
wherein m1 is an integer of 1 to 3; and
m2 is an integer greater than 1; and
q1 is an integer greater than 1.

9. (canceled)

10. (canceled)

11. The compound of claim 1, wherein R³ is an optionally substituted C₆ to C₁₀ aryl.

12. The compound of claim 1, wherein R¹ is an optionally substituted alkylene bridge of C₁ to C₆ carbon atoms where one or more carbon atoms can be replaced by O and R² is C₂ alkene; or
wherein R¹ is an optionally substituted alkylene bridge of C₁ to C₆ carbon atoms where one or more carbon atoms can be replaced by O and R² is epoxide.

13. (canceled)

14. The compound of claim 1, wherein —R¹—R² is —(CH₂)ₚO—(CH₂)_{q}(CH═CH₂) or —(CH₂)ₚ-epoxide, wherein p and q are independently an integer of 1 to 6.

15. The compound of claim 1, wherein —R³—R⁴ is -phenyl-alkene or -phenyl-epoxide.

16. The compound of claim 1, selected from the group consisting of the following compounds:

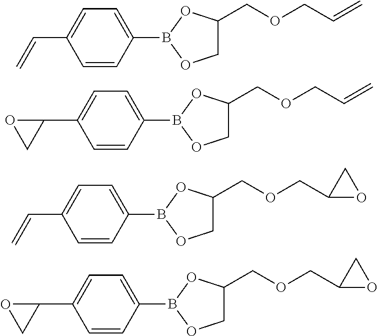

17. (canceled)

18. The coating of claim 1, wherein the ratio of the compound of Formula (I) to the elastomer is in the range of 4:1 to 1:4.

19. The coating of claim 1, wherein the coating is capable of acting as a self-healing agent in the presence of moisture.

20. A method of self-healing cracks that form in a coating according to claim 1, wherein said crack is exposed to moisture thereby inducing esterification between hydroxy groups located on either side of said crack, thereby at least partially bonding the edges of said crack together.

21. The method of claim 20, wherein the edges of the crack are bonded together by at least 80%.

22. The method of claim 20, wherein the moisture is atmospheric moisture.

23. The method of claim 20, wherein the method is performed at room temperature.

24. (canceled)

25. A method for synthesizing the coating of claim 1 comprising:
(a) preparing a mixture comprising a compound of Formula (I) of claim 1, pentaerythritol tetrakis (3-mercaptoptopionate) (PTMP), 3,6-dioxa-1,8-octanedithiol (DODT), elastomer and a photoinitiator; and
(b) curing the mixture of step (a).

26. The method of claim 25, wherein the elastomer is a reaction product of:
i. a cyclic aliphatic isocyanate or cyclic aliphatic diisocyanate;
ii. a polyol; and
iii. a chain extender; or
wherein the elastomer comprises repeating units of Formula (IIA), (IIB), (IIIA), or (IIIB) as defined in claim 5.

27. (canceled)

28. The method of claim 25, wherein step (b) comprises thermal curing, redox curing or UV curing; or
wherein step (b) comprises irradiating the mixture under UV light for at least one hour.

29. (canceled)

30. The method of claim 25, further comprising: (c) drying the product of step (b) for at least one day.
